(19) United States
(12) Patent Application Publication
(10) Pub. No.: US 2009/0225032 A1
(43) Pub. Date: Sep. 10, 2009

(54) Overload regulating structure for trackball device

(76) Inventor: Cheng-Chi Wang, Ping Chen City (TW)

Correspondence Address: MUNCY, GEISSLER, OLDS & LOWE, PLLC, P.O. BOX 1364, FAIRFAX, VA, 22038-1364, US

(21) Appl. No.: 12/073,509

(22) Filed: Mar. 6, 2008

(51) Int. Cl. G06F 3/033

(52) U.S. Cl. 345/167

(57) ABSTRACT

An overload regulating structure for trackball device includes a base, a top cover, a ball, a circuit board, a plurality of rotatable shafts and disks, and an overload regulator. The ball is three-point supported in the base between the rotatable shafts and the overload regulator. When the ball is subject to an overload, springs in the overload regulator are compressed, allowing the ball to sink into a locating recess in the base and be restricted from rotating freely and thereby protected against the overload. When the ball is released from the overload, the springs in the overload regulator elastically push the ball to the original three-point supported position again.

### FIELD OF THE INVENTION

The present invention relates to an overload regulating structure for trackball device, and more particularly to an overload regulating structure that protects a trackball device against damaged internal components caused by an overload applied to a trackball.

### BACKGROUND OF THE INVENTION

A trackball device is mainly used with a computer to control the movement of a cursor on a screen and functions similar to the conventional mouse. However, there is another type of trackball device particularly designed for use with a video game machine to control the movement of a cursor thereof. By rotating a trackball, signals are transmitted to control the cursor to move on the screen.

A conventional trackball device includes abase, a ball, and a plurality of shafts. The base is provided with a locating recess, in which the ball is rotatably positioned. The shafts are mounted in the base and have a disk each mounted thereon. When the ball is rotated, it brings the shafts and the disks to rotate at the same time, so that movement signals are transmitted to a circuit board for the latter to control the cursor to move on the screen.

In the conventional trackball device, the ball is directly positioned in the locating recess in the base. When an operator applies an excessive force to rotate the ball, the ball tends to collide with or rub other internal components to cause undesirable damage and accordingly, errors in transmitting signals.

### SUMMARY OF THE INVENTION

A primary object of the present invention is to provide an overload regulating structure for effectively protecting a ball in a trackball device from an overload, so that the trackball device is not damaged due to collision or rubbing of the ball with other internal components caused by the overload.

To achieve the above and other objects, the overload regulating structure for trackball device according to the present invention includes a base, a circuit board, a plurality of shafts, a plurality of bearing sets, a ball, and an overload regulator. The base has an open-topped locating recess formed on a bottom thereof. The plurality of bearing sets are embedded in sidewalls of the base, and the shafts are separately connected at two ends to one of the bearing sets. The overload regulator includes two seats being screwed to one sidewall of the base using fastening elements and having a slide slot each for receiving a spring therein. A bar-shaped supporting element has two ends received in the two slide slots on the overload regulator, such that the springs have one end pressed against the sidewall of the base and the other end pressed against the supporting element. A roller is mounted on and around the supporting element. With the springs in the overload regulator, the supporting element may be elastically moved rearward by the overloaded ball or elastically pushed forward by the springs.

In the present invention, the ball is normally three-point supported on and between the plurality of shafts and the roller. When the ball is subject to an overload and gradually sinks to the locating recess, the ball would push against the roller, bringing the supporting element to move rearward along the slide slots, so that the springs in the slide slots are compressed to store energy. And, when the ball has fully sunk into the locating recess, it is restricted from rotating freely. When the overload is released, the springs in the slide slots release the stored energy and elastically push the supporting element forward, so that the roller pushes the ball upward to the originally three-point supported position.

With the above arrangements, the ball in the trackball device is effectively protected against overload to avoid damages to the trackball device caused by colliding or rubbing of the overloaded ball with other internal components.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an overload regulating structure for trackball device according to a preferred embodiment of the present invention;

FIG. 2 is a top view of the overload regulating structure for trackball device shown in FIG. 1;

FIG. 3 is a sectional view taken along line 3-3 of FIG. 2; and

FIG. 4 is a sectional view showing a ball in the trackball device is protected against overload through the overload regulating structure of the present invention.

### DETAILED DESCRIPTION OF THE PREFERRED EMBODIMENTS

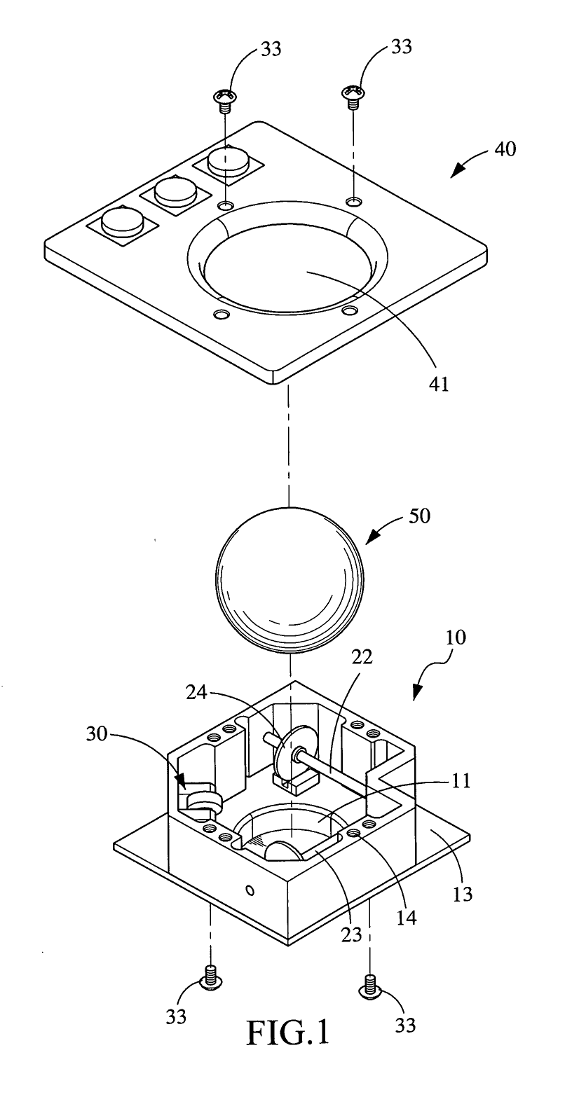

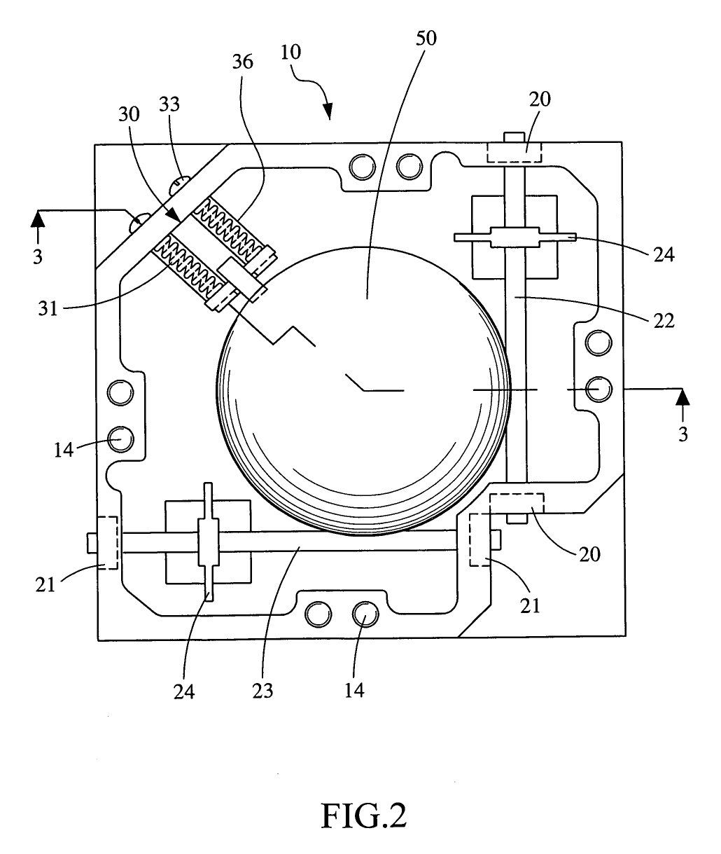

Please refer to FIGS. 1 and 2, which are exploded perspective and assembled top views, respectively, of an overload regulating structure for trackball device according to a preferred embodiment of the present invention. As shown, the overload regulating structure includes a base 10, a circuit board 13, a y-direction bearing set 20, an x-direction bearing set 21, a y-direction shaft 22, an x-direction shaft 23, a top cover 40, a ball 50, and an overload regulator 30.

The base 10 includes an open-topped locating recess 11 formed on a bottom thereof and a plurality of screw holes 14 formed on sidewalls thereof. The x-direction bearing set 21 is embedded in one of the sidewalls of the base 10 corresponding to the x-axis, and the y-direction bearing set 20 is embedded in one of the sidewalls of the base 10 corresponding to the y-axis. The circuit board 13 is attached to an underside of the base 10 for processing control signals sent from the ball 50 when the latter is rotated, and the processed control signals are sent to a screen for moving a cursor thereon.

The y-direction shaft 22 is connected at two ends to the y-direction bearing set 20, and the x-direction shaft 23 is connected at two ends to the x-direction bearing set 21. Both the y-direction shaft 22 and the x-direction shaft 23 have a disk 24 mounted thereon.

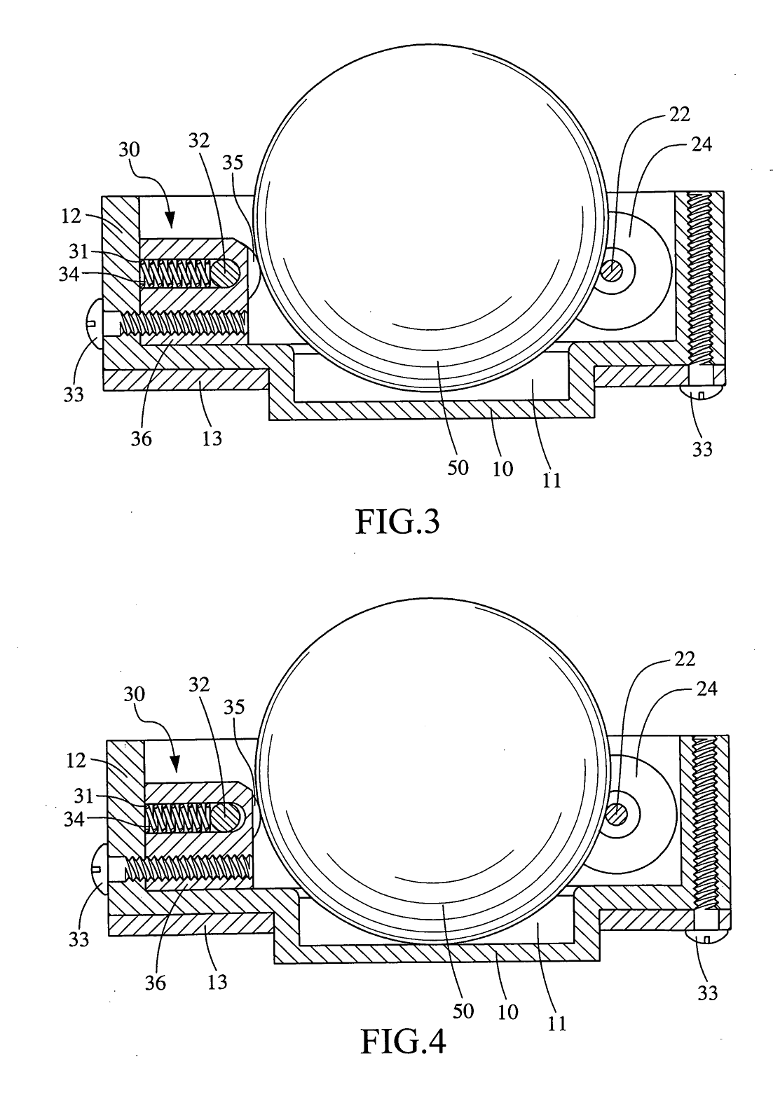

Please refer to FIG. 3, which is a sectional view taken along line 3-3 of FIG. 2. The overload regulator 30 has two seats 36 being screwed to a first sidewall 12 of the base 10 with a plurality of fastening elements 33. The two seats 36 are provided with a slide slot 34 each. A spring 31 is provided in each of the slide slots 34 with one end pressed against the first sidewall 12 of the base 10 and the other end pressed against a supporting element 32. The supporting element 32 is in the form of a round bar having a roller 35 mounted thereon, and has two ends received in the slide slots 34 on the two seats 36. With the springs 31 provided in the two slide slots 34, the roller 35 mounted on the supporting element 32 may be pushed by the ball 50 to elastically move rearward or pushed by the springs 31 to elastically move forward along the slide slots 34. To assemble the overload regulating structure for trackball device, first position the ball 50 in a space defined between the y-direction shaft 22, the x-direction shaft 23, and the roller 35, so that the ball 50 is three-point supported in the base 10. Then, attach the top cover 40 and the circuit board 13 to the upper and the lower side of the base 10, respectively, using fastening elements 33.

FIG. 4 is a sectional view showing the ball 50 in the trackball device is protected against overload through the overload regulating structure of the present invention. As shown, the ball 50 is normally three-point supported between the roller 35, the y-direction shaft 22, and the x-direction shaft 23.

When the ball 50 is subject to an overload, the overloaded ball 50 will apply a force on the roller 35, bringing the supporting element 32 to move rearward and compress the springs 31 into an energy-storing state. Meanwhile, the ball 50 finally sinks into the locating recess 11 under the load constantly applied thereto, and is restricted by the locating recess 11 from rotating freely. That is, the overload regulating structure for trackball device according to the present invention effectively provides the overload protection function by allowing the ball 50 to sink into the locating recess 11 under an overload without causing damages to the external spherical surface of the ball 50 and other components in the trackball device.

A user may manipulate the ball 50 to rotate in different directions via a ball opening 41 provided on the top cover 40. When the ball 50 is rotated, the y-direction shaft 22 and the x-direction shaft 23 are brought by the ball 50 to rotate, and the disks 24 mounted on the two shafts 22, 23 in turn transfer movement signals from the rotating ball 50 to the circuit board 13 for processing, so as to control the moving directions of the cursor on the screen.

What is claimed is:

1. An overload regulating structure for trackball device, comprising a base having an open-topped locating recess formed on a bottom thereof and a plurality of bearing sets embedded in predetermined sidewalls thereof; a top cover attached to an upper side of the base; a circuit board attached to a lower side of the base; a ball rotatably positioned between the base and the top cover; a shaft supported on each of the plurality of bearing sets; a disk mounted on each of the shafts; and an overload regulator mounted to a predetermined sidewall of the base;
wherein the overload regulator includes a plurality of slide slots, in each of which a spring is received; a supporting element having two ends movably received in the slide slots; and a roller mounted on and around the supporting element; and
wherein the ball is three-point supported in the base between the shafts and the overload regulator;
whereby when the ball is subject to an overload to force the roller and accordingly, the supporting element to elastically move rearward along the slide slots, the ball is allowed to sink into the locating recess and be restricted from rotating freely.

2. The overload regulating structure for trackball as claimed in claim 1, wherein when the ball sinks into the locating recess, the springs in the slide slots of the overload regulator are compressed into an energy-storing state.

3. The overload regulating structure for trackball as claimed in claim 2, wherein when the ball is released from the overload, the ball is pushed by energy stored in the springs of the overload regulator to the original three-point supported position in the base.
